(19) United States
(12) Patent Application Publication
(10) Pub. No.: US 2016/0185032 A1
(43) Pub. Date: Jun. 30, 2016

(54) CLIP/TRANSPORT UNIT

(71) Applicant: BRÜCKNER MASCHINENBAU GMBH & CO. KG, Siegsdorf (DE)

(72) Inventors: Ludwig ECKART, Traunstein (DE); Michael BAUMEISTER, Traunstein (DE); Anthimos GIAPOULIS, Traunstein (DE); Markus UNTERREINER, Marquartstein (DE); Tobias HÄUSL, Traunstein (DE); Emmerich KULINYAK, Bergen (DE)

(73) Assignee: BRÜCKNER MASCHINENBAU GMBH & CO. KG, Siegsdorf (DE)

(21) Appl. No.: 14/654,222

(22) PCT Filed: Nov. 28, 2013
(86) PCT No.: PCT/EP2013/003598

§ 371 Date: Jun. 19, 2015

(30) Foreign Application Priority Data
Dec. 20, 2012 (DE) 10 2012 025 486.5

(51) Int. Cl. B29C 55/00

(52) U.S. Cl. CPC B29C 55/00

(57) ABSTRACT

The invention relates to an improved clip/transport unit, characterized by the following features, among others: the clip/transport unit is divided into a clip part and a transport part, the clip/transport unit has a volume or weight fraction of at least 25% composed of one or more composite materials.

The invention relates to a clip transport unit as per the preamble of claim 1.

Stretching installations are used in particular for the production of plastics films. So-called simultaneous stretching installations are known in which a plastics film can be stretched simultaneously in a transverse direction and in a longitudinal direction. Likewise, sequential stretching installations are known in which a plastics film is stretched in two successive stages, for example firstly in a longitudinal direction and then in a transverse direction (or vice versa).

An already-known transverse stretching installation or transverse stretching stage within a stretching installation has become known for example from U.S. Pat. No. 5,797,172 A. In said prior publication, a material web to be stretched, that is to say generally a plastics film, is taken hold of by way of clips, which are fastened to chains and which are arranged movably, on both sides of the material web to be stretched, on encircling guide paths. The clips are in this case moved in succession from a run-in zone (in which the edge of, for example, a plastics film to be stretched is taken hold of) via a stretching zone (in which the opposite clips on the guide rail sections are moved away from one another with a transverse component diverging from the transport direction) to a run-out zone, and then, on a return path, back to the run-in zone, wherein, in the run-out zone, the film can undergo for example a final relaxation and/or heat treatment process.

In this case, the clips are composed of a so-called clip transport unit which comprises firstly the clip part itself and secondly the so-called transport part, that is to say the clip device and the transport device. In the already-known prior art according to U.S. Pat. No. 5,797,172 A, the so-called transport part is ultimately a chain part, as the clips for the discussed transverse stretching installation are connected to one another by way of corresponding chain links.

According to said previously published prior art, the clip transport unit is in this case supported by way of slide elements on two opposite sides of a guide rail, on the one hand, and additionally on a support rail provided below the guide rail, on the other hand.

Instead of slide elements of said type, it is however likewise also possible to use roller elements in order to permit movement of the clip transport unit, supported for example on a guide rail and on a weight-sustaining running rail. This is known for example from DE 39 28 454 A1. Said document describes a guide rail in the form of a so-called monorail, which guide rail has a rectangular cross section. In this case, the clip transport unit is supported by way of running wheels, so-called rollers, which roll on the top side and on the bottom side and on the two vertical sides situated offset in a horizontal direction, whereby the clip transport unit can be moved along said guide rail. A clip transport unit of said type is likewise suitable in particular for a stretching frame, that is to say a transverse stretching installation.

Furthermore, devices for stretching a moving material web have become known which can be used as part of a simultaneous stretching installation. A stretching installation of said type emerges, so as to be known, for example from DE 37 41 582 A1. In the case of this exemplary embodiment, too, the clip transport units are supported, by way of rollers which rotate on horizontal and vertical spindles, on the top side and the bottom side and on the two vertical sides, which are situated offset from one another in the horizontal direction, of a guiding and weight-sustaining rail which is of rectangular cross section. In addition, a further control rail is also provided, by means of which, via scissor-type chain links, the spacing of the clips to one another in the machine direction MD can be set differently in the region of the diverging simultaneous stretching zones.

Finally, so-called simultaneous stretching installations have also become known, for example from EP 4 55 632 A1 and from DE 44 36 676 A1. In these cases, too, the guide rail simultaneously serves as a support rail for the clip transport units. The clips are in this case driven not by a chain but by way of linear motors along the path of circulation, which is composed of positionally fixed primary parts and of secondary parts that move with the clip. Both the primary and the secondary parts may be fitted at one or more positions in relation to the guide rail, that is to say above or below or to the side of the guide rail.

Even in the case of this drive configuration using magnetic fields, it is likewise again possible for use to be made of slide and/or roller elements for holding the clip transport units in longitudinally movable fashion on the guide and support rail.

Independently of these differently configured stretching installations, there is the basic problem of ensuring that the friction coefficients for the rolling and/or sliding friction do not become too high. This is because the acting friction makes it necessary for lubricant, in particular oil, to be used in order to reduce the friction. Here, it is pointed out that not only does the friction contribute to considerable power losses, but also, the power losses arise, in particular in the case of friction bearing arrangements, in the form of friction losses, that is to say in particular the power lost is released in the form of heat to the guide system. At high speeds, it is therefore necessary for conventional slide guides to be cooled in order to prevent decomposition (cracking) of the lubricating oil).

By contrast, it is an object of the present invention to considerably improve the clip transport units described in the introduction, that is to say in particular the stretching installations described in the introduction.

The object is achieved according to the invention in accordance with the features specified in claim 1. Advantageous refinements of the invention are specified in the subclaims.

Therefore, in the context of the invention, a considerable improvement is attained in the case of both simultaneous and sequential or transverse stretching installations. According to the invention, this is achieved, or at least jointly achieved, by virtue of the moving masses being reduced, without this leading to other disadvantages in the case of stretching installations of said type. The reduction of the masses leads inter alia in particular to a reduction in friction and ultimately to a reduction in energy input.

Furthermore, more lightweight designs of the clip or clip chain units lead to a reduction in energy input in the case of chain and pantograph systems and in the case of systems controlled by linear motor.

It is therefore proposed in the context of the invention that the corresponding clip transport units be produced, to a minimum degree (in relation to the volume and/or in relation to the overall weight of the transport unit), from lightweight materials, that is to say in particular composite materials. Composite materials are materials made up of two or more different materials. Here, the composite material exhibits different, and generally better, properties than the material properties of its individual components. In other words, in the context of the invention, it is possible in this way to produce not only a very lightweight transport unit but a lightweight transport unit which furthermore withstands high forces and loads. The properties of the composite materials are in this case dependent on various effects, as is known. The individual starting materials are connected by way of cohesion and/or a form fit of the components involved. Here, in the context of the invention, fiber composite materials are particularly preferred, wherein said materials may for example also be provided in a matrix composed of aluminum, magnesium or other composite materials.

Owing to the reduction in friction and thus power losses, the amount of lubricant, and also the fouling of the foil by the lubricant, can be reduced.

A further consequence of the reduction in friction consists in the reduction in cooling power.

A further direct consequence of the reduction in weight is that less weight has to be dragged by the chain, that is to say a reduction in drive power is realized.

The mentioned weight reduction however also results in a reduction in the centrifugal forces at the reversal points in the run-in and run-out areas. Furthermore, the reduction in weight also yields a reduction in the chain longitudinal forces, because the drag forces, the preload forces and the centrifugal pull action are reduced. In this way, it is then for example also possible for the chain pins to be configured in optimized fashion, or the structural forms can be made smaller, which in turn contributes to a further reduction in weight.

In the case of simultaneous pantograph systems, the weights both of the lever units and of the clip and chain parts and of the control units on the guide and control rail can be reduced.

In the case of simultaneous systems controlled by linear motor, the weight of the clip part and of the transport part can be reduced, which leads to a reduction of the energy input into the primary parts. A further energy saving is attained in the case of sequential stretching installations which are driven by way of transport chains and sprockets.

In the case of roller-guided clip chain systems, it is possible for both the clip part and the chain part (that is to say generally the transport part) to be produced entirely or partially from lightweight materials. This is analogously true for slide bearing-guided clip chain systems, which will be described here by way of example.

An additional improvement can likewise be attained through a substantial decoupling of the weight forces from the other, normally process-related forces, such as stretching forces and, for example, chain longitudinal forces in the case of sequential stretching installations.

The invention will be discussed in more detail below on the basis of exemplary embodiments. In this case, in detail:

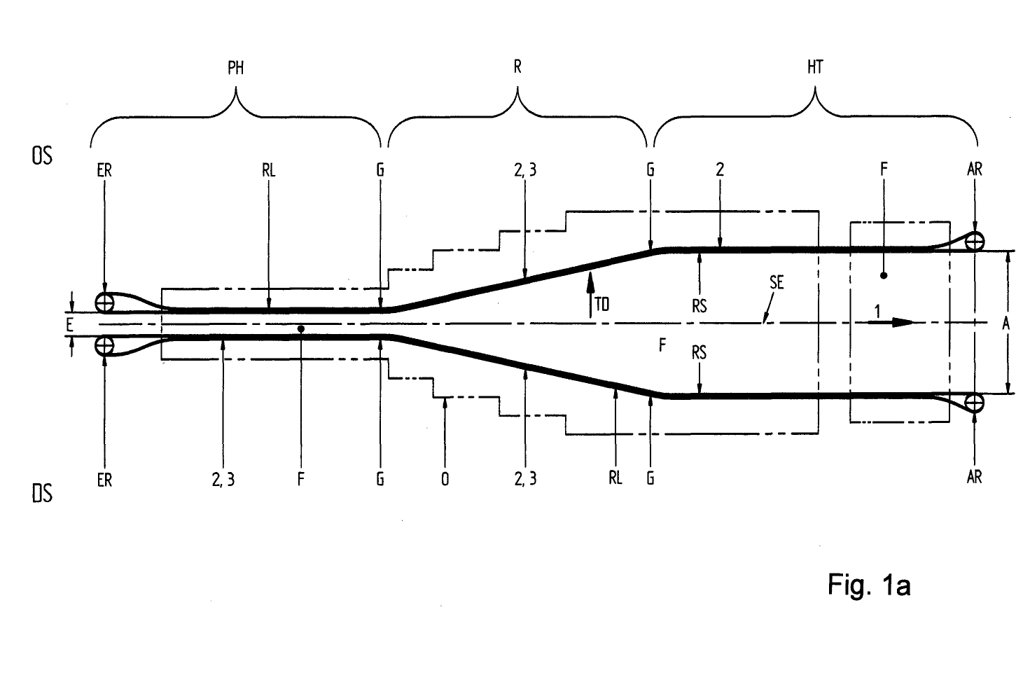

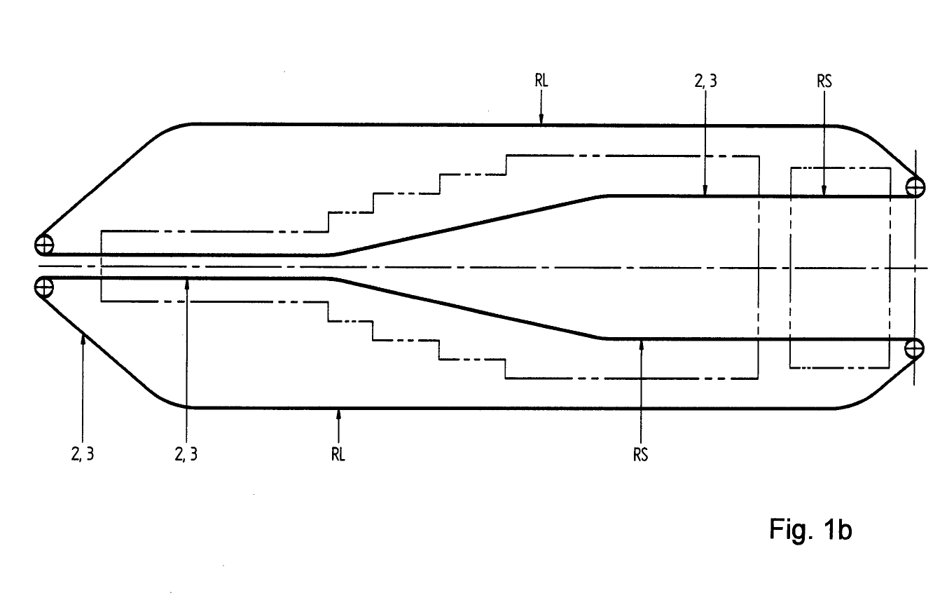

FIG. 1a shows a schematic plan view of a transverse stretching installation with a common beam structure for the process side and the return side within the furnace;

FIG. 1b shows an embodiment, modified in relation to FIG. 1a, of a return side for the transport chain which is separate from the process side and outside the furnace;

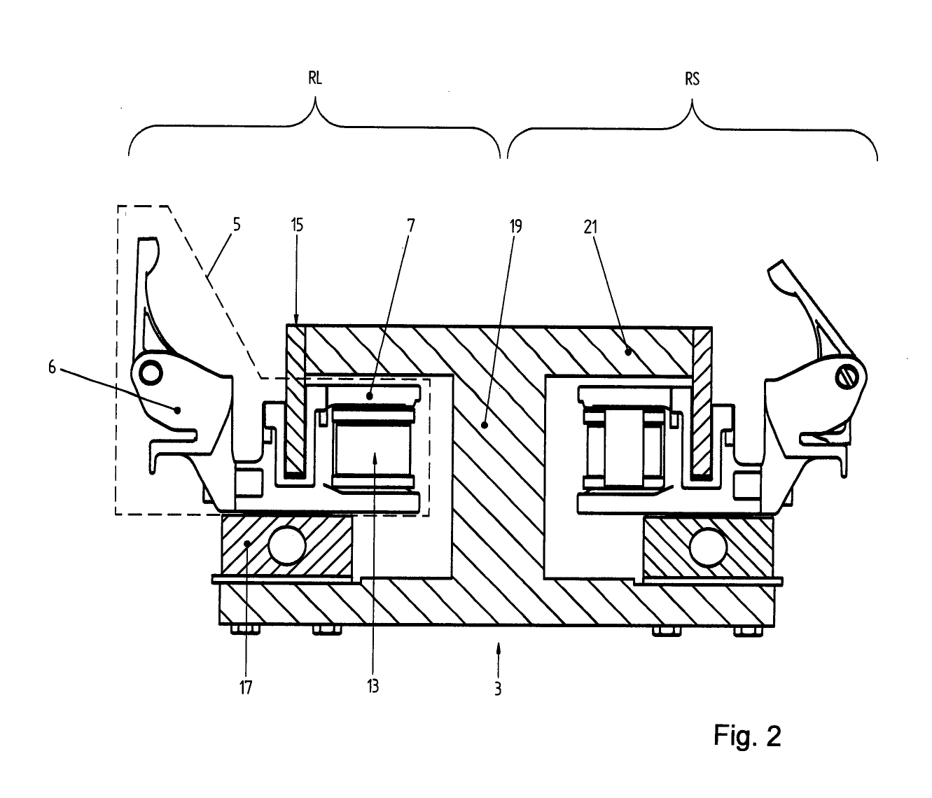

FIG. 2 is a schematic cross-sectional illustration through a beam structure for the guide path of a transport chain with associated clips;

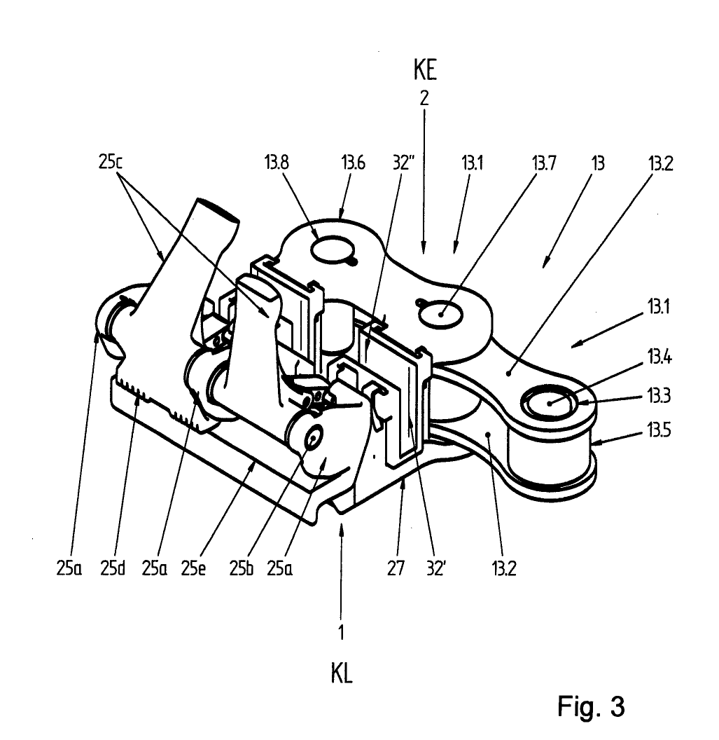

FIG. 3 shows a clip with parts of the transport chain in a three-dimensional detail illustration;

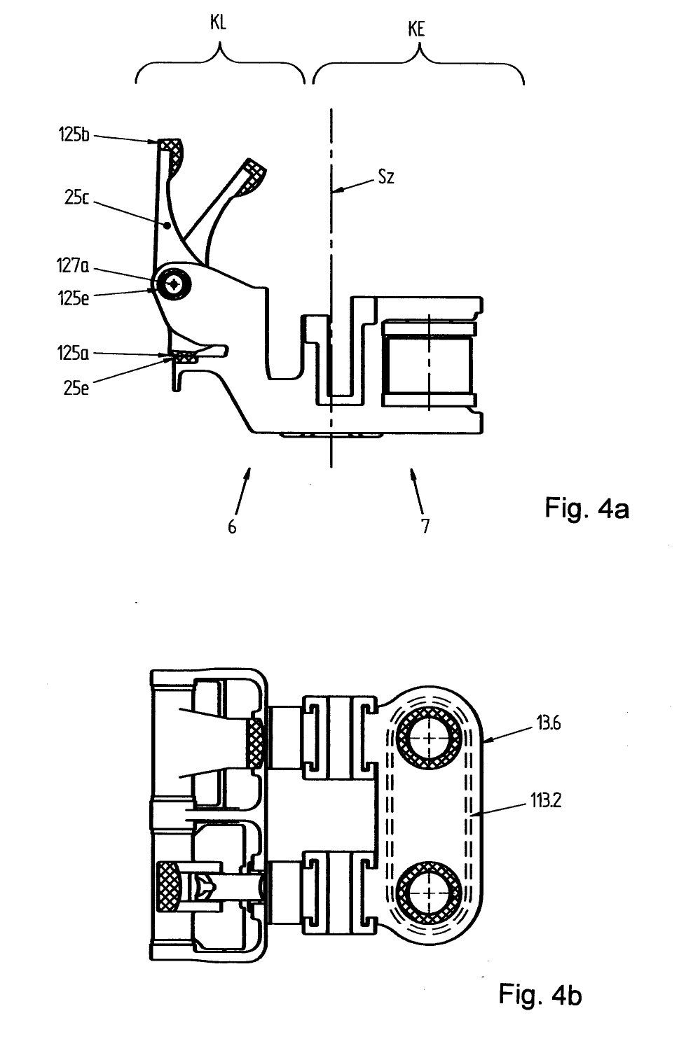

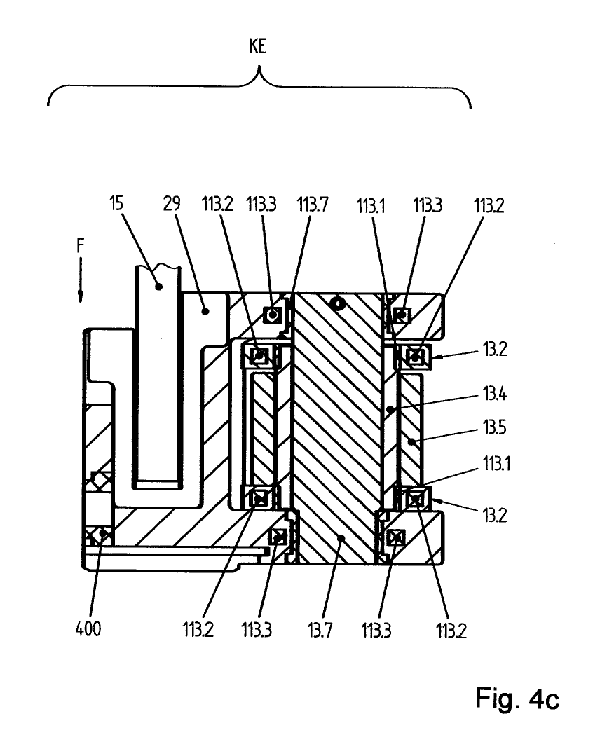

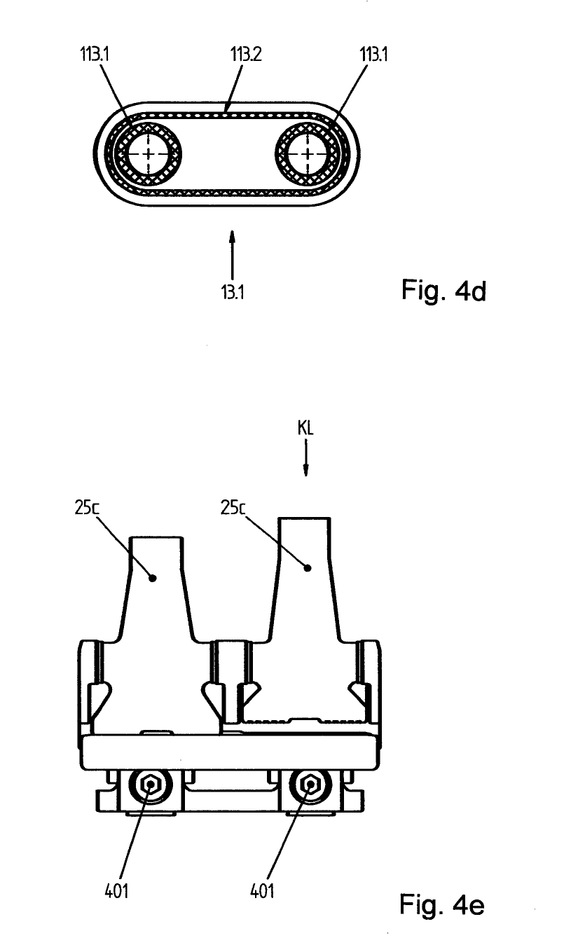

FIG. 4a shows a clip according to the invention in a side view parallel to the feed movement of the clip (for unique designation of the directions, a coordinate system has been plotted, wherein m denotes the transport direction along the guide rail, t denotes the direction of the vector normal thereto and z denotes the direction collinearly with respect to the guide rail);

FIG. 4b shows a corresponding plan view of the exemplary embodiment as per FIG. 4a;

FIG. 4c is a vertical cross-sectional illustration through the transport chain, and explanation of the structure of the transport chain;

FIG. 4d is a schematic plan view of a chain link design;

FIG. 4e shows a schematic plan view of a clip transport unit for illustrating how the clip part is screwed to the transport part;

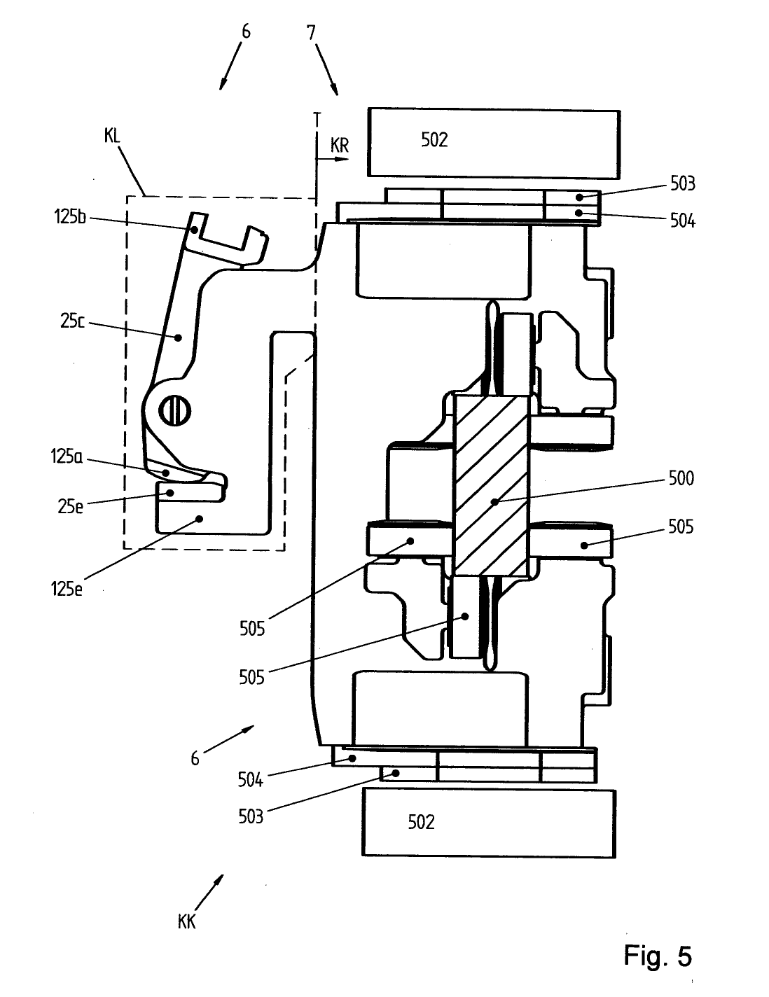

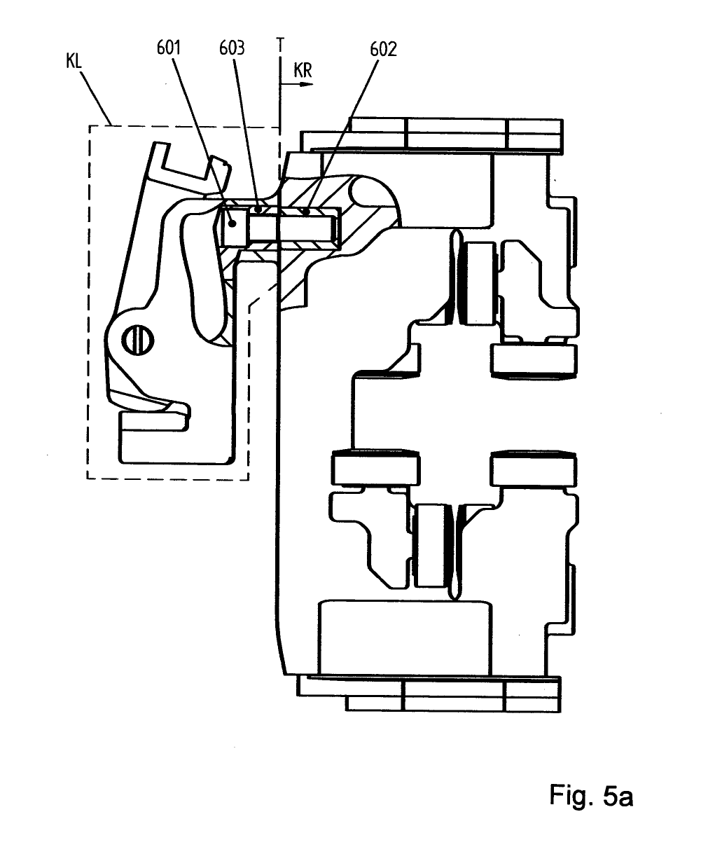

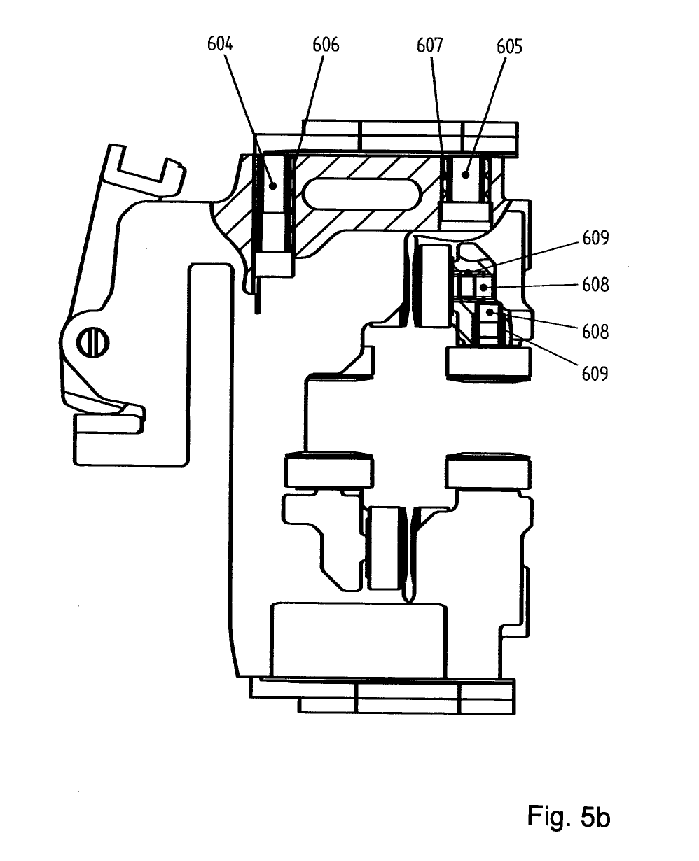

FIG. 5 is a schematic vertical side-on illustration perpendicular to a monorail as a guide and support rail with regard to a linear motor-driven clip embodiment;

FIG. 5a is an illustration corresponding to FIG. 5 for explanation of the fastening of the clip part to the chain part;

FIG. 5b is a further illustration relating to FIG. 5 for explanation of the fastening of the clip part to the chain part;

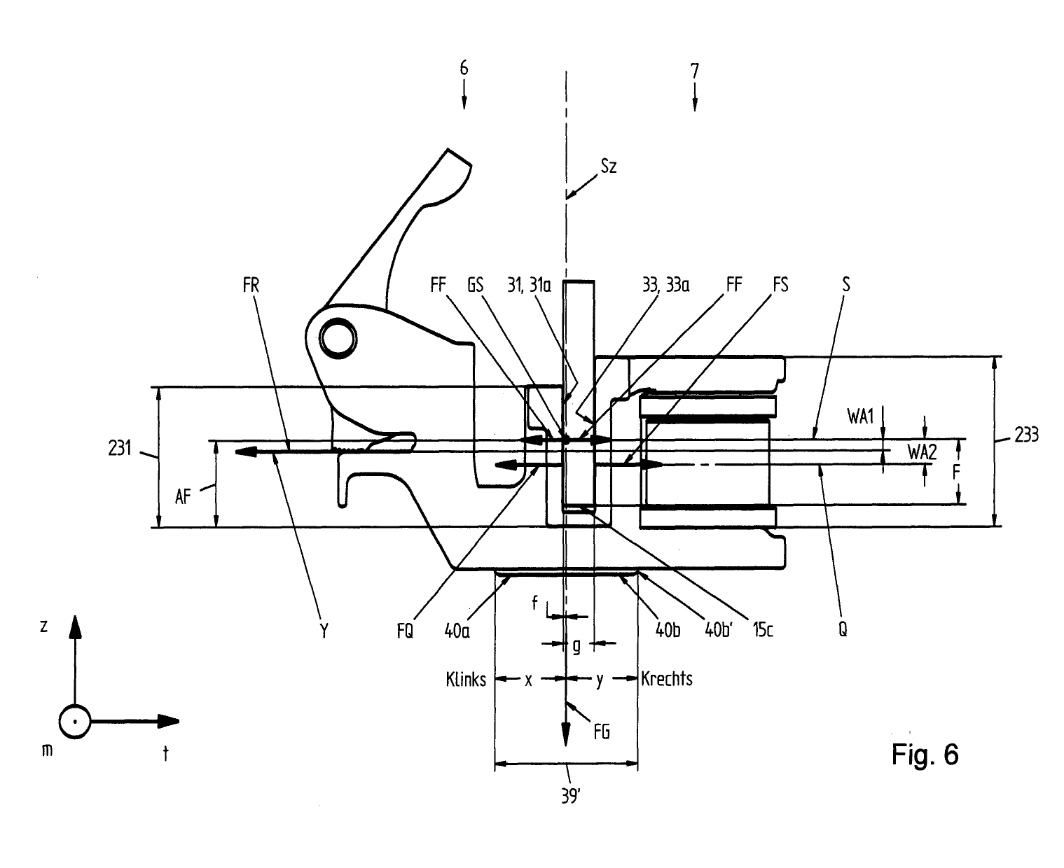

FIG. 6 shows a schematic side view of the clip shown in FIGS. 4a to 4e, with the forces acting thereon and action planes in which said forces arise and act;

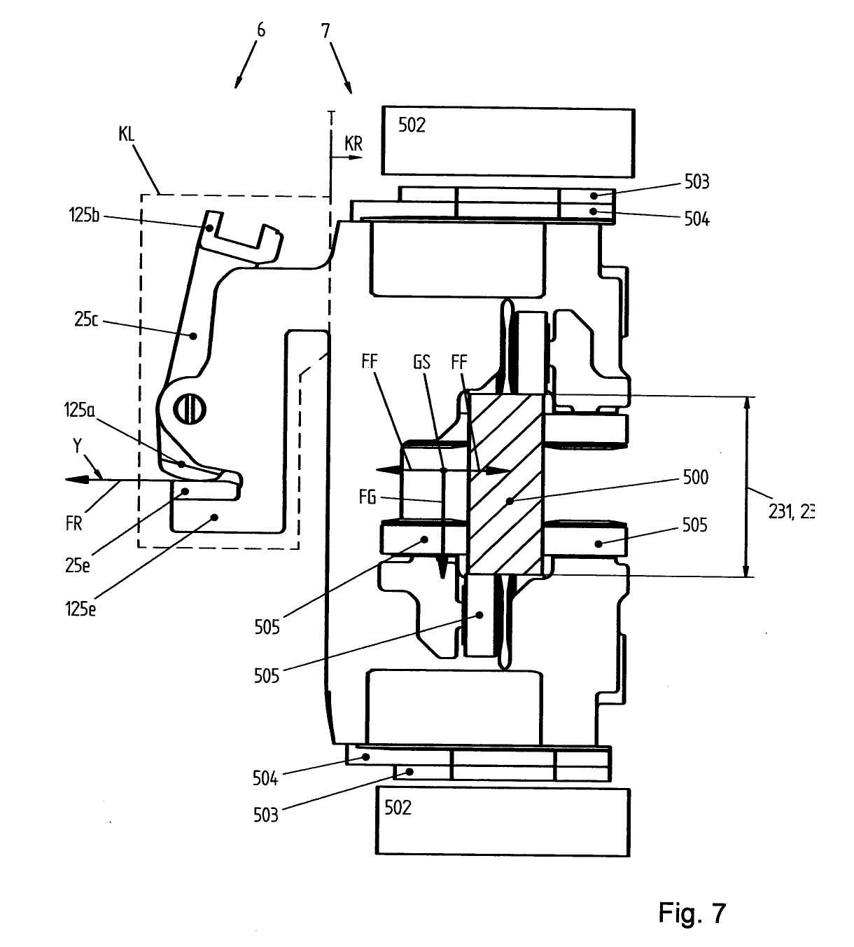

FIG. 7 is an illustration corresponding to FIG. 5, in the case of a linear motor-driven chain transport unit; and

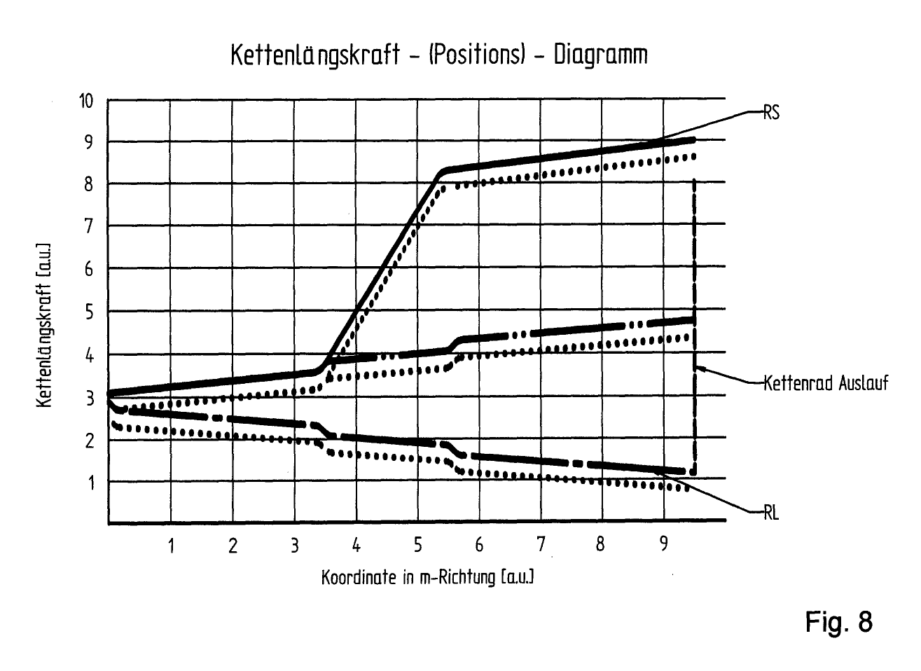

FIG. 8 shows a diagram of chain longitudinal force versus position, for illustrating the forces that act on the clips.

A transport system of a stretching installation is generally composed of a weight-sustaining running rail and of a guide rail, which may however also be combined in one rail unit. In the case of pantograph systems, it is generally the case that two rail units are provided, wherein the first rail system performs a guidance and weight-sustaining function, and the second serves for the control of the clip movement. All of these details are familiar to a person skilled in the art and need not be explained in any more detail here.

As an exemplary embodiment of the invention, a description will initially be given here of a widthwise stretching installation with a slide bearing arrangement, that is to say a transverse stretching installation.

### Basic Construction

The widthwise or transverse film stretching installation described here, which will hereinafter also be referred to for short as TD stretching installation (TD=Transverse Direction), has two drive systems of symmetrical form, which lie symmetrically with respect to a central plane of symmetry SE running vertically with respect to the plane of the drawing. FIG. 1a shows the two drive systems which are arranged symmetrically with respect to the plane of symmetry SE in the drawing-off direction 1, wherein, between the two drive systems which circulate on closed paths 2, the material web to be treated, that is to say stretched, said material web being in particular in the form of a plastics film F, is moved through along the drawing-off direction 1. The discussed TD stretching installation may in this case also be part of a sequential stretching installation, which conventionally comprises a longitudinal stretching stage positioned upstream of the transverse stretching installation (transverse stretching frame) (in case of doubt, said longitudinal stretching stage may however also be positioned downstream of the transverse stretching stage). The stretching installation shown in FIG. 1a comprises two chain transport systems 3 which are driven in the direction of circulation on the two encircling paths 2.

A uniaxial (that is to say if a longitudinal stretching installation is positioned upstream of the transverse stretching installation shown) or unstretched film F (wherein, below, a film will be referred to even though a stretching installation of said type can generally be used for the corresponding treatment and transverse stretching of a web for treatment F, such that the invention is in this respect not restricted to a plastics film web) runs into the stretching installation in the run-in region E and, there, is taken hold of and clamped at both edges 8 by clips (to be discussed in more detail below, and shown for example in FIG. 2), specifically on the so-called operator side (OS) and on the drive side (DS). The film F is then heated in a subsequent preheating zone PH and subsequently supplied to a stretching zone R in order, there, to be stretched in the transverse direction TD. Subsequently, the stretched film F runs through various heat treatment zones HT, in which a relaxation of the film can also take place. At the end of the stretching installation, in the so-called run-out zone A, the film is disengaged from the clips and then exits the transverse stretching machine, that is to say the transverse stretching installation TD.

Below, the clip transport units KT will also be referred to, which will hereinafter in part also be designated as clip chain units KK. Said clip transport unit KT or clip chain unit KK comprises, firstly, the so-called clip part 6, which is connected to the chain or transport part 7 bridge B situated in this case at the bottom, wherein the bridge B will hereinafter in part also be referred to as clip bridge B. Depending on point of view, the clip bridge B (which, in terms of volume and weight, makes up only a small fraction in relation to the clip part 6 and in relation to the transport or chain part 7) may also be regarded as belonging to the clip part 6, for example. In the example discussed, in which a transport chain is used, reference is preferably made to a chain part 7, which is part of the clip chain unit KK. In an exemplary embodiment for a linear motor-driven stretching installation discussed further below, reference is made not only to the clip part 6 but preferably also to a transport part 7 (as in this case no transport chain is provided) which, together with the clip part 6, forms the so-called clip transport unit KT.

As is known, said clip chain units KK, that is to say the said clip part 6 and the chain part 7, are situated in a circulating transport system 3 which comprises firstly a beam structure 11, and a circulating chain 13, on which the said clip parts 6 are fastened or formed so as to run together therewith. The beam structure 11 comprises a guide rail 15. In addition to said guide rail 15 there is also provided a support rail 17 which bears the weight of the chain and of the clips and which, below, will also in part be referred to as weight-sustaining running rail 17. As also emerges from the following explanation, the transport chain with the clips that can move concomitantly thereon are guided and supported on the guide monorail 15 and on the support rail 17 by way of a slide bearing arrangement.

The discussed support structure may be used as a common support structure for the transport system both on the stretching side process side RS and on the return side RL (FIG. 2).

FIG. 2 shows a cross section through the transport system, specifically with a common support structure 11 which, aside from a centrally arranged, rather vertically running member 19, comprises a transverse member 21 which is supported by said vertically running member and on each of the opposite ends, pointing away from one another, of which the rail 15, that is to say the so-called guide rail 15, which runs from the top downward and which is of rectangular cross section, is mounted, this specifically being provided on the stretching side RS, on the one hand, and on the return side RL, on the other hand, as mentioned. In the case of a thus common support arrangement, the transport system is situated jointly within a furnace O (FIG. 1a). Said furnace surrounds the preheating zone PH, the stretching zone R and the post-heating zone or relaxation zone HT, such that ultimately only the diverting and drive systems provided on the inlet side and outlet side are situated outside the furnace O. Otherwise, it is also possible for a separate beam structure to be provided for the stretching side RS and the return side RL, such that in this case, only the stretching-side beam structure with the associated guide rail and the weight-sustaining running rail runs through the furnace O, and a correspondingly designed further beam structure is provided on the return side outside the furnace O. A corresponding design is shown in a schematic plan view in FIG. 1b.

As mentioned, the transport chain 13 is driven and diverted both on the run-out side and on the run-in side by way of run-out and/or run-in wheels AR and ER.

To make the system flexible, it is furthermore the case that joints G for the guide rail and the support rail are provided at various locations; this will be discussed in more detail further below. Through different setting of said joints, it is possible in particular to set different transverse stretching conditions in the stretching zone R.

### Optimization of the Installation by Way of a Weight Reduction

A weight reduction through the use of lightweight structural materials reduces the power losses arising from friction, and reduces the drive power, as the mass to be moved is reduced. As positive secondary effects, lubricant quantities can be reduced, and the cooling power can be reduced.

Furthermore, the so-called centrifugal pull (=centrifugal force Fz=mv2) at the reversal points in the run-in and run-out areas is reduced. Since the centrifugal pull is defined as the weight per meter of the chain transport units multiplied by the square of the installation speed, it is clear that, to attain high installation speeds, the weight per meter of the chain transport units must be reduced in order to be able to reduce the chain longitudinal forces.

In this respect, reference is also made to FIG. 8, which schematically illustrates the profiles of the chain longitudinal force along the process and return side of the transport system as a solid line.

In order, for example, to be able to compare the weights per meter of the lightweight design with the standard embodiments composed of cast steel, some definitions are required, as the lightweight design differs in terms of construction from the cast steel embodiment, and a direct comparison would thus be possible only if the lightweight design were exactly identical to the cast steel embodiment in terms of form and functional dimensions, aside from the different densities of the materials.

A standard cast steel embodiment is defined as a clip transport unit composed of cast steel which, together with a guide and support rail construction (and control rail construction in the case of pantograph systems), forms the transport system. Said standard system has fixed functional dimensions such as, for example, the chain pitch, the clip spacings, the MD stretching ratio, the position of the film plane in relation to slide bearings or roller bearings etc. These fundamental relationships are familiar to a person skilled in the art and, in part, will be discussed again further below in the consideration of the introduction of forces.

A comparison of the weight per meter of the standard cast steel embodiment with that of the lightweight design is now made possible if, within the identical guide and support rail construction (and control rails in the case of pantograph systems), the same functional dimensions are used. The clip transport unit composed of cast steel is thus replaced, in an existing guide and support rail construction, with the lightweight design of identical configuration and identical dimensions, without the need, for example, to exchange the sprockets or to implement other measures in terms of mechanical design or method implementation.

Under this definition, a comparison of the weights per meter is then possible. In practice, one meter of the cast clip transport unit would be compared with one meter of the lightweight design. The same principle can self-evidently also be implemented with very high accuracy with modern CAD simulations.

Therefore, it is provided in the context of the invention that the clip transport unit KT has, for example, a weight per meter which is at least 25% lighter than a corresponding (structurally similar) cast steel embodiment of the clip transport unit KT. In other words, the weight per meter in the case of a design of the clip transport unit according to the invention in structurally identical form (that is to say with identical shaping, dimensions etc.) should lead to a weight saving of at least 25% in comparison to a corresponding cast steel embodiment, exclusively by virtue of the fact that, in the context of the invention, use is made of composite materials, for example. For example, use may be made of a composite material with two or more materials, preferably with fiber composite materials which are embedded in a matrix. It is preferably the intention here to realize a volumetric and/or weight saving of at least 25%, in particular at least 30%, 40%, 50%, 60%, 70% or even at least 80% or, in the extreme case, 90%, in relation to a structurally similar or structurally identical cast steel embodiment.

Therefore, in the context of the invention, it is also assumed that at least 25% and preferably more than 30%, 40%, 50%, 60%, 70%, 80% or even more than 90% of the weight fraction of the clip transport unit KT is composed of materials composed of or comprising one or more materials from the group aluminum, magnesium or fiber composite materials.

Therefore, to obtain clear definitions and dimensioning rules in the context of the invention, it is preferably assumed that at least 25% of the volume (volume of the material used) or 25% of the weight of a corresponding clip transport unit according to the invention is composed of or comprises lightweight materials in the form of composite materials, in particular fiber composite materials, including carbon fiber or glass fiber composite materials. Said volumetric or weight fraction should preferably make up at least 25%, in particular at least 30%, 40%, 50%, 60%, 70%, 80% or, in the extreme case, at least more than 90%, of a clip transport unit according to the invention.

More lightweight constructions of the clip or clip chain units furthermore lead to a reduction in the energy input in the case of chain and pantograph systems and in the case of linear motor-controlled systems.

Through the reduction in friction and thus power losses, the lubricant quantity, and also the fouling of the film by the lubricant, can be reduced.

A further consequence of the reduction of friction is a reduction in cooling power.

A direct consequence of the weight reduction is that less weight has to be dragged by the chain, the linear motors or scissor-type lattice, that is to say a reduction in drive power is realized.

An improvement in the overall situation, that is to say a reduction in the friction coefficients, an associated improvement with regard to the slide bearing arrangement and a possible lubricating arrangement and/or a reduction in abrasion can be realized by virtue of the transport chain 13 as a whole together with the clip chain units KK (that is to say generally for the clip transport units KT) and the clip parts 6 and the transport or chain parts 7, or at least parts thereof, being realized in a lightweight design. Only steel and other cast materials have hitherto been used as standard materials for this purpose.

Therefore, in the context of the stated exemplary embodiments, it is provided that the transport system KT and thus the so-called transport or chain parts 7 and/or the clip parts 6 (that is to say the clip bodies 6) or major parts thereof are produced from or composed of, for example, relatively lightweight materials in the form of composite materials including fiber composite materials (in particular carbon fiber composite materials (CFK)).

In the case of a further reduction in weight or reduction in friction losses through the use of CFK materials, it is for example possible for the clip part 6, but also the transport or chain part 7, as shown and described for example in FIG. 3, to also be partially or entirely formed using composite technology. In this case, it is possible for parts of the clip part 6 and also of the chain part 7 to be produced from one piece, or to be constructed from two or more components and connected to one another.

It would be possible, for example in the case of a clip body (clip part 6), for the main fraction of the clip body to be composed of a carbon fiber composite material, wherein only moving spindle parts 127a composed of metal are used and, for example, the so-called blade flap 25c is composed of a composite material or of a light metal, wherein the blade flap 25c is equipped at least with a clamping tip or clamping head 125a which is composed of metal or light metal, similarly to the clip table 25e which interacts therewith and which may be equipped or lined for example at least with a metalized steel or light metal layer. To ensure a magnetic opener and closer function for the blade flap, the lever tip should be equipped with a magnetic insert part 125b (FIG. 4a).

All of the discussed measures for reducing weight yield relevant advantages. Furthermore, by means of the weight reduction, it is possible for the chain longitudinal forces to be dramatically reduced, as is schematically illustrated by the dashed-dotted lines in FIG. 8. For example, at the run-in side, at the MD position=0, the forces resulting from the preload of the chain and the centrifugal pull forces (=centrifugal forces) act, which, as already discussed, can be reduced by way of the weight reduction. Overall, it can be seen that the entire curve profile is now shifted, in parallel, toward lower chain longitudinal forces.

All these measures consequently furthermore lead to further improvements in the construction of the clip transport units. For example, the reduction in weight yields a reduction in the chain longitudinal forces, as the drag forces and the preload forces and centrifugal pull action are reduced. In this way, it is then for example possible for the chain pins to be of more optimized configuration, or it is possible for the structural forms to be reduced in size, and a further weight reduction can be realized.

Reference is furthermore made once again to FIG. 8, which shows the dependency of the chain longitudinal force on the position on the encircling path 2. Here, FIG. 8 shows generally that the chain longitudinal force is at its greatest at the drive of the run-out region, because the entire transport chain 13 is pulled by way of the driven run-out wheel. The conditions with regard to the chain longitudinal force at the run-out and run-in areas vary in a manner dependent on the input wheel provided in the run-in region E, which is possibly driven with part load.

### Chain Construction

The discussed further weight reduction or reduction in friction losses for example through the use of CFK materials is suitable in particular for a chain arrangement 13 in which, as discussed on the basis of FIG. 3, a chain inner link and a chain outer link follow one another alternately. This is advantageous in particular because, in the case of this construction, the components, in particular the fiber composites, are subjected only to tensile load. This is advantageous because, here, no redirection of force occurs (as in the case of rotary chains).

The transport chain 13 itself is preferably composed of an inner link and an outer link in alternation, that is to say not of chain parts that are equipped, in between, with a cranked configuration, wherein successively in each case the lower-lying section of a chain link is joined to a following higher section of a subsequent chain link. In this regard, reference is likewise made in particular to FIG. 3. Thus, a chain arrangement is preferably realized in which the transport chain is of similar construction to a simple roller chain. Equally, however, other types of articulated chains are also possible, such as for example multiple roller chains, rotary chains etc. In this respect, reference is also made to other already-known chain constructions.

In this respect, a large chain pitch has also proven to be expedient, whereby weight and costs can be further reduced. In this context, it likewise proves advantageous (as has already been indicated on the basis of FIG. 3) if, per clip body 6, not only one clip lever, that is to say not only one blade flap 25c, but for example two blade flaps 25c are provided so as to be seated adjacent to one another in the longitudinal direction of the clip, that is to say in the longitudinal direction of the so-called clip parts 6 and thus in the feed direction of the clip, although it is also possible for only one blade flap 25c to be provided, as in the prior art (furthermore, it is also conceivable for not just two but more blade flaps to be arranged adjacent to one another per clip body).

Here, by way of example, a chain inner link 13.2 of the transport chain is described in FIGS. 4c and FIG. 4d. For the mounting of the axle pins 13.7 and in order to attain the required rigidity, insert parts 113.1 are provided. To be able to accommodate the required tensile strength, arising predominantly from the chain longitudinal forces FKi, tension straps 113.2 are inlaid in addition to the preimpregnated sheets (prepregs). The hardening and compaction of the composite is performed in a vacuum and autoclaves using the conventional methods such as for example prepreg or RTM (resin transfer molding) methods. As materials, use is preferably made of long-fiber sheets and composites, and the conventional high temperature-resistant polymers and epoxies.

The other components of the clip chain units KK are also produced in an analogous manner. FIG. 4c shows, by way of example, a section through the chain part KE through the axis central point of the chain pin 13.7 at right angles to the guide rail 15. The illustration shows a situation in which the clip and chain parts 6, 7 are produced separately along a parting joint T. The two parts are connected for example by way of screw connections using screws 401, wherein the nut part of the screw connection is configured as an insert part 400, as shown in FIG. 4c.

It is self-evidently not ruled out that the clip chain units KK may also be manufactured only from one or more parts.

### Linear Motor-Driven Simultaneous Stretching Installation

Below, a linear motor-driven simultaneous stretching installation will be discussed, such as is basically known from the prior publications EP 455 632 and DE 44 36 676, to the entire content of disclosure of which reference is made. In these embodiments, the guide rail 500, shown in cross section in FIG. 5, simultaneously serves as support rail of the clip transport units KT and thus of the transport parts 7. Here, the clip transport units KT with the clip parts 6 are driven not by way of a chain but by way of linear motors along the encircling path, which is composed of positionally fixed primary parts 502 and of secondary parts 503 which move with the clip transport units KT. In other words, the clips, that is to say the clip parts 6 with the transport parts 7, are longitudinally displaced and moved by means of the secondary parts 503 along the positionally fixed primary parts 502, that is to say along the guide rail 500, which in this case also serves simultaneously as transport rail 500 (monorail). The transport parts 7 correspond to the chain parts 7 described in the preceding exemplary embodiment, as the transport parts in the preceding exemplary embodiment constitute part of a transport chain.

Both the mentioned primary parts and the mentioned secondary parts may be fitted in one or more positions in relation to the guide rail 500 (top, bottom, sides). The secondary parts 503 are composed of permanent magnets which are fastened in a holding cage 504 which in turn is fastened to the clip body. The clips are mounted by way of roller bearings 505.

FIG. 5 shows the guide and weight-sustaining rail 500 (monorail) in a cross section in relation to its longitudinal direction. Said guide and weight-sustaining rail has a rectangular cross section in the exemplary embodiment shown. In each case two pairs of rollers or running wheels 505 which are arranged offset with respect to one another in a vertical direction and which rotate about vertical axes (not illustrated in any more detail) run on the two vertically oriented running surfaces 500a, which are situated so as to be offset with respect to one another and parallel. On the top horizontal running surface 500b and the parallel, that is to say horizontal running surface 500b situated below the former running surface with a spacing, there runs in each case at least one further pair of rollers which rotate about horizontal axes. Thus, the entire propelled clip is held so as to be guided, and supported in terms of weight, by said rail 500. In this case, as mentioned, the clip transport unit KT is divided into the clip part 6 itself and the transport or roller part 7 projecting therefrom. Here, the clip transport unit (KT) is divided into the clip part 6 (with a bridge B situated at the top) and the adjoining clip or transport part 7 along a vertical and virtual parting plane T shown in FIG. 5. Here, said parting plane T runs parallel to the vertical running surfaces 500a of the guide and support rail 500. As will be discussed in more detail below, the clip transport unit KT is balanced with respect to a gravitational force plane Sz (m-z plane through the center of gravity GS), that is to say is in equilibrium here.

As already described in the example of the slide bearing arrangement of the clip chain unit, it is possible also in the case of the linear motor-driven stretching installation (LISIM) to use clip insert and reinforcement parts composed of lightweight materials. As an example here, FIG. 5a, along the parting joint T, is discussed. To keep the torque through the clip body as low as possible, the clip and the clip blade 25c are for example manufactured substantially from the lightweight material. To attain the required strength in the screw connection, by means of screw 601, of the clip part with respect to the roller part KR, insert parts 602 or reinforcement parts 603 are inserted at the positions appropriate to the construction. In structural terms, it is generally likewise possible for stiffening structures (for example reinforcement straps) to be inserted at any desired positions within the lightweight composite, wherein this is implemented as appears necessary in accordance with engineering knowledge, for example from FEM simulations.

The magnetic secondary parts 504 and 503 are connected by way of screw connections 604 and 605 to the respective insert parts 606 and 607 in an analogous fashion, as has been illustrated by way of example in FIG. 5b.

The same principle of the insert and reinforcement parts is also used in the case of the screw connections of the roller bearings 505 by way of screw connections 608 and insert parts 609.

As already mentioned, reinforcement mechanisms such as tension straps and high-strength metal or polymer components may be used in the lightweight structural composite at all locations at which this appears expedient from the aspect of engineering knowledge and which have been determined for example by way of simulations.

Even in the case of either the clip part 6 or the transport part 7 alone (for example along the parting line T), or, by way of corresponding embodiments, the entire clip with the clip part 6 and the transport or chain part 7, being of lightweight construction using a lightweight material, preferably in the form of CFK, it is furthermore possible to realize a substantially decoupled, tilting moment-free system, which will be discussed in more detail below.

By contrast to the exemplary embodiment shown, it would self-evidently also be possible for the linear motor-driven stretching installation discussed above, that is to say the clip transport unit propelled along a guide path by linear motor drive, to entirely or partially have, instead of the rolling bearing arrangement shown, a corresponding slide bearing arrangement, as has basically been described on the basis of the above-discussed exemplary embodiment for a transverse stretching installation.

Finally, in this respect, reference is also made to conventional transverse stretching installations by means of a roller bearing arrangement, such as are known for example from the already-cited DE 39 28 454 A1. This also applies equally with regard to the simultaneous stretching installations equipped with a conventional mechanical drive such as are known for example from the likewise already-cited DE 37 41 582 A1, in which the clip spacing in the stated zone sections can be set differently for example by way of scissor-type chain links. In this case, the clip units, the control units and also the scissor-type chain links can be entirely or partially of corresponding lightweight design, specifically through the use of one or more of the above-stated materials.

### Description of the Composite Materials, in Particular of the Fiber Composite Materials

In all of these exemplary embodiments, however, the clip transport units KT, that is to say the clip part itself and/or the transport part itself, may be improved, on the basis of the exemplary embodiments already described in the introduction, by virtue of the corresponding parts being composed of or comprising composite materials, in particular long-fiber composite materials, in a volumetric fraction of more than 25%, in particular more than 30%, 40%, 50%, 60%, 70%, 80% or even more than 90%, on their own or in combination with further materials.

What experts understand under the term “composite materials” can be gathered for example from Wikipedia (https://de.wikipedia.org). According thereto, composite materials are to be understood to mean all material combinations of two or more materials. Normally, a composite material is composed of a so-called matrix into which one or more other materials, so-called property components, are embedded. Here, the components of a composite material may themselves again be composite materials. The composite material exhibits better material properties than its individual components. Possible examples are particle composite materials, fiber composite materials, such as a glass fiber-reinforced matrix, metal matrix composites (MMC), preferably long-fiber, carbon fiber-reinforced matrices, self-reinforced thermoplastics, aramid fiber-reinforced plastic (AFP), fiber-ceramic composites (ceramic matrix composites (CMC)), layered composite materials; TiGr composites, fiber-reinforced aluminum, sandwich constructions, bimetals, Hylite, a sandwich structure composed of a plastics panel embedded between two aluminum panels/foils, and ceramic-fiber composite materials.

Composite materials are thus fundamentally multi-fiber or mixed materials. Here, a fiber composite material is composed generally of two main components, specifically an embedding matrix and reinforcing fibers.

The substance-based division of the materials into polymers (plastics), metallic, ceramic and organic materials gives rise to the basic combination possibilities for composite materials. Here, it is sought, on an application-specific basis, to combine the different advantages of the individual materials, and eliminate the disadvantages, in the final material.

The matrix, and also the property components, may be composed of metals such as for example aluminum, magnesium etc., of polymers (thermosets), resins such as polyester resin, polyurethane resin (polyurethane), epoxy resin, silicone resin, vinyl ester resin, phenol resin, acrylic resin (PMMA) etc., or of combinations of these.

Use is preferably made of fiber composite materials, in particular long-fiber fiber composite materials. It is however basically also possible to use particle composite materials, layered composite materials, impregnated composite materials, and structural composite materials. The fibers may run in one or more particular directions, or have preferential directions. Fiber composite materials may be produced in layered fashion.

As is known, the matrix determines the appearance of the composite material, and in particular the fiber composite material. Here, said matrix also serves to hold the reinforcing fibers in their position and accommodate and distribute the corresponding forces and stresses. At the same time, the matrix protects the fibers against external influences, in particular also mechanical and chemical influences.

The fibers provide the fiber composite material with the required strength, including the required tensile strength and/or flexural strength.

As a matrix, use is made, for example, of lightweight materials, inter alia aluminum or magnesium. It is however also possible for other metals to be used as a matrix. It is likewise possible for various ceramics to be used as a matrix for corresponding composite materials, that is to say in particular fiber composite materials. Finally, in this connection, it should also be mentioned that carbon and carbon fiber-reinforced carbon (CFC) may be used.

Otherwise, for fiber composite materials, use is preferably made of fiber-plastics composite materials, in which, as matrix, use is made of polymers, specifically for example
duromers (thermosets, plastics resin etc.)
elastomers
thermoplastics.

The connection of the composite materials (matrix and property components) is performed using the conventional methods, such as for example injection molding, insert techniques, vacuum casting etc. The further processing may be performed using known procedures and methods, including hardening and compaction of the composite. This compaction is generally performed in a vacuum and autoclaves. Such methods have become known for example under the terms “prepreg” or “RTM (resin transfer molding)”.

Use may basically be made of all corresponding, and in this respect also known methods, such as for example:
vacuum pressing methods
prepreg methods
vacuum infusion methods
fiber winding methods
fiber spraying methods
injection molding methods
transfer molding methods
pultrusion methods or
sheet molding compound methods (SMC).

The composite materials may be provided with reinforcement substances, structural components and insert components in accordance with generally known methods.

As materials, use is preferably made of long-fiber sheets and composites and the conventional high temperature-resistant polymers and epoxies.

Furthermore, it is self-evidently also possible for other materials to be provided or used. In the case of fiber composite materials, use is made in particular of carbon fiber composite materials. In this connection, for the clip part 6 and for the chain part 7, use may be made in particular of cast materials which are composed of one of the following substances or may comprise several of the stated substances.

In all of these discussed exemplary embodiments, this thus leads to a drastic reduction in weight of the clip transport units regardless of the specific type of stretching installation, whereby not only the friction rolling and/or friction sliding values are considerably reduced, but also the required energy input and the heating in the region of the guide and/or support rail is considerably reduced in relation to conventional installations.

Owing to the lightweight design, it is possible, through the configuration of individual components within the clip assembly, to realize substantial decoupling of the acting forces, without tilting moments or with greatly reduced tilting moments.

It is however furthermore also possible for further measures to be provided in order to yet further enhance or support these effects.

### Additional Decoupling of the Forces

Furthermore, in the context of the invention, it may furthermore be provided that, in the transport system according to the invention, by contrast to the prior art, ideally complete, that is to say 100%, decoupling of the vertical and horizontal forces is additionally realized in conjunction with the weight and center of gravity distribution of the lightweight design.

In the context of a refinement of the invention, it is sought for at least the weight of the clip parts 6 and of the transport parts 7 to be distributed in balanced fashion symmetrically with respect to a virtual plane of weight symmetry Sz (FIG. 6).

In the case of the transport chain-driven clips, this means that, here, there should be a balanced weight distribution between the clip bodies, that is to say the clip parts 6, and the transport parts 7, wherein here, in general, the virtual parting line T runs or may run in the region of the clip bridge B (if appropriate more or less directly adjoining the clip part 6 itself and/or the chain part 7 itself).

In the case of a linear motor-driven stretching installation, the respective clip part 6 and the transport part 7, which is equipped with the linear motor drive and comprises the so-called secondary part, should, in terms of weight, be configured more or less such that the center of gravity plane Sz lies within the guide rail. The stretching forces and centrifugal forces act on the guide rail symmetrically and centrally via the roller bearings.

In the example of the slide chain transport system, therefore, the weight (which determines the overall weight of the clip body 6) of the clip part 6 and the weight of the chain or transport part 7 is distributed symmetrically with respect to the virtual plane of weight symmetry Sz and thus as uniformly as possible with respect to the weight-sustaining running surface 39, wherein the virtual plane of weight symmetry Sz runs through the center of gravity GS and, in so doing, parallel to the running surfaces 31, 33 of the slide shoe 39′. In this way, it is sought to ensure that, firstly, no tilting or twisting moments are generated by an asymmetrical weight distribution of the transport chain 13 and/or the clip part 6, and that, secondly, the contact pressure on the weight-sustaining running surface 39 is distributed as symmetrically as possible with respect to the axis of weight symmetry or plane of weight symmetry Sz, in order to minimize the overall friction coefficients in relation to the weight. Thus, by means of the overall arrangement, it is prevented or at least substantially ensured that, as mentioned, the transport chain and the clip body are not acted on by tilting moments or torques, which would otherwise lead to an increase in friction forces during the propulsion of the transport chain.

Here, FIG. 6 shows, by way of example, the center of gravity GS of the clip chain unit KK in the case of a transport chain-driven transverse stretching installation, and FIG. 7 shows, by way of example, the corresponding center of gravity GS of the clip transport unit KT for a linear motor-driven simultaneous stretching installation, which center of gravity, in the exemplary embodiment shown, comes to lie in the region of the guide rail slide body 29, that is to say in the central region thereof. The center of gravity must self-evidently be considered in all three spatial directions; reference is thus made hereinafter to center of gravity planes. It is here that the weight force FG acts, the vector of which is plotted in FIG. 6. Said weight force vector FG lies in this case in a virtual plane of weight symmetry Sz, which runs perpendicular to the plane of the drawing and which runs in the longitudinal direction through the clip body, along which the clip body is moved on a straight guide path. The weight force vector FG or the virtual plane of weight symmetry Sz runs in this case centrally and symmetrically with respect to the slide bearings 40 provided on the clip underside 25f, and in so doing perpendicularly intersects the slide running surface 39.

On the underside of the clip chain unit KK there may however also be formed, instead of a single slide bearing 40, two or more separate slide bearings 40a, 40b whereby the clip chain units KK (that is to say the respective clip parts 6 with the chain parts 7 connected thereto) with the corresponding weight are supported in sliding fashion on a corresponding support and/or running rail 17 (FIG. 2). The underside of said slide bearings 40, 40a, 40b (by means of which the clip chain units KK, with their weight, are supported) is in part also referred to as weight-sustaining running surface 39.

The one or more slide bearings 40, 40a, 40b have a maximum width extent 39′ which is shown for example in FIG. 6. Said maximum width extent corresponds to the sum of the values x+y, wherein x constitutes the spacing between the vertical center of gravity plane Sz and the furthest remote point of the slide element 40a on the clip side and the distance y constitutes the spacing from the center of gravity plane Sz to the furthest remote point of the slide element 40b on the chain side. It is thus possible for a single slide element 40 or multiple slide elements 40a, 40b which are arranged spaced apart from one another to be provided in the region of the maximum width extent 39′. Here, the center of gravity plane Sz should preferably extend centrally through the maximum width extent 39′ (=x+y). If the center of gravity plane Sz extends through said maximum width extent eccentrically with respect to the slide elements 40, 40a, 40b, such that the lateral spacing X differs from the lateral spacing Y, then the slide elements should be dimensioned in terms of their length such that the contact pressures are identical with respect to the center of gravity plane Sz. In other words, therefore, if the (equal) component weight forces Kleft and Kright which act at the furthest remote points 40a′ and 40b′ (see FIG. 6) run, with respect to the center of gravity plane Sz, such that the spacing x differs from the spacing y, then in this case, too, it should be ensured that the contact pressures to the left and to the right of the center of gravity plane Sz are equal, which has the result that the surfaces of the slide element or of the multiple slide elements 40a, 40b to the left and right of the center of gravity plane Sz must differ in terms of size. Through the adaptation of the slide surface, it can be ensured that the clip chain unit KK does not tilt. Thus, the weight forces of the transport chain are supported, in a manner free from tilting moments and torques, specifically entirely independently of the horizontally acting forces, on the support rail.

All further forces acting on the transport chain 13, that is to say on the individual links thereof such as the clip parts 6 and the chain parts 7 are, owing to the construction principle selected in the context of the invention, oriented perpendicular to the weight force FG. Here, however, not only are said further forces oriented perpendicular to the weight force FG, they also act on the respective clip body, and thus on the transport chain, more or less at the same or approximately the same height, whereby it is ensured that said transverse forces do not introduce any additional tilting moments or torques into the clip body and thus into the transport chain, such that, here, too, said transverse forces do not contribute to an increase in friction action.

Here, as can be seen from the drawings, the height of the chain force-sustaining running surface 31a and the height of the stretching force-sustaining running surface 33a may by all means differ. It is essential merely that the stretching, transverse, lateral surface and/or centrifugal forces acting thereon perpendicular to the weight forces FG act in the region of the chain force-sustaining running surface 31a and of the stretching force-sustaining running surface 33a and, in this case, in particular, the associated vectors act in a common plane or in planes lying close to one another, such that tilting moments or torques which otherwise occur, and which could act on the clip body 6 and thus on the transport chain 13, are prevented or minimized to the greatest possible extent.

Therefore, the drawings also show a chain force-sustaining running surface height 231 and a stretching force-sustaining running surface height 233 (for example FIG. 6), which describe the respective height or effective height from the lowermost to the uppermost point of the respective slide surface 31a or 33a (said slide surface need not be continuous from the lowermost to the uppermost point but may have slide surfaces formed so as to be spaced apart from one another, so as to form a free intermediate space). What is essential is merely the effective overall height of the respective chain force-sustaining and/or stretching force-sustaining running surface height 231 and 233, respectively, which is supported on, that is to say interacts with, the corresponding running or outer surface 15a, 15b of the guide rail 15. It is specifically in this region that, with the exception of the weight force FB, all of the further occurring forces running perpendicular to said weight force are intended to act, such that here, it is likewise the case that no tilting moments and torques can be introduced at the guide rail. In other words, it is the intention that all of the forces, which in this case act perpendicularly on the guide surfaces and slide surfaces, are supported in tilt-free and torque-free fashion on the guide rail, as well as the weight force FG, which acts perpendicular thereto and is intended to be supported in tilt-free and torque-free fashion on the support and weight-sustaining rail 17, by virtue of said weight vector, too, intersecting the corresponding running surface 17a of the support rail 17 in the region of the effective slide surface formed there.

In the case of a linear motor drive, the relationships described on the basis of FIG. 6 for a transport chain drive basically apply analogously, wherein there, it is then not the clip chain units KK themselves but the linear motor-driven clip transport units KT that are used, as can be seen in the cross-sectional illustration from FIG. 7.

In the embodiment presented on the basis of FIG. 6, in the case of a transverse stretching installation using a transport chain, or in the exemplary embodiment presented on the basis of FIG. 7, for a linear motor-driven simultaneous stretching installation with separately driveable clip transport units KT, the center of gravity plane Sz is now situated within the width of the guide rail 15. As before, the stretching force FR acts centrally and symmetrically with respect to the lateral roller system. The chain longitudinal forces are eliminated, and owing to the symmetrical construction, the centrifugal forces FF act in the stretching force plane Y or in a plane parallel thereto with a small spacing WA1, which lies for example slightly above or below the stretching force plane Y, wherein the stretching force plane Y coincides with the height position of the clip table, on which the edge 8 of the film F is held clamped in the stretching zone.

Furthermore, it likewise emerges from FIG. 6 and FIG. 7 that, in a manner dependent on the respective track section on the guide path 2, the respective clip chain unit KK is acted on not only by the weight force but also by further forces generally running more or less perpendicular to said weight force, such as for example the centrifugal forces FF, the lateral guidance forces FS and transverse forces FQ (wherein the lateral guidance forces and the transverse forces are omitted in the case of a linear motor-driven drive; they are not generated or introduced by the chain longitudinal force). In the preferred embodiment discussed, it is provided here that all of said additional forces, which run more or less perpendicular to the weight force and thus more or less parallel to the stretching or film plane, act on the guide rail 15 above the lower edge 15c thereof or act on the guide rail within the remote delimiting edges of the slide or roller bearing arrangements (that is to say between the lower and upper delimitations of the slide or roller bearing arrangements).

The stretching force acts on the centrally and symmetrically with respect to the lateral roller system, that is to say the transport or chain part 7. However, in this case, the so-called chain longitudinal forces would be omitted, because owing to the symmetrical design, the centrifugal forces act in the stretching force plane.

The advantages according to the invention are attained in particular if the system is optimally correspondingly balanced between the clip part 6 and the chain part 7. In this case, the center of gravity plane Sz is arranged parallel to the m-z plane within the thickness of the guide rail 15, wherein, in FIG. 6, f denotes the horizontal and thus perpendicular spacing between the vertically running center of gravity plane Sz and the vertically running chain force-sustaining running surface 31a, and g denotes the corresponding horizontal spacing to the vertically running stretching force-sustaining running surface 33a, that is to say the values f and g are ≧0. The slide elements of the weight force-sustaining guide are situated far outside this center of gravity plane, such that no tilting moments can arise. The slide element system is furthermore optimized such that identical or virtually identical contact pressures symmetrically with respect to the center of gravity plane Sz are attained either by way of the spacings x, y or by way of different surface sizes.

1. A clip transport unit for a stretching installation, in particular a transverse, longitudinal and/or simultaneous stretching installation, in which clip transport units, as part of a transport chain, are movable along a guide and/or support rail, having the following features:
the clip transport unit is divided into a clip part and a transport part, characterized by the following further features:
the clip transport unit has an at least 25% volumetric or weight fraction composed of one or more composite materials.

2. The clip transport unit as claimed in claim 1, wherein the clip part and/or the transport part are/is composed of or comprise(s) one or more composite materials, in particular long-fiber fiber composite materials, in a volumetric or weight fraction of more than 25%, in particular more than 30%, 40%, 50%, 60%, 70%, 80% or more than 90%.

3. The clip transport unit as claimed in claim 1, wherein the clip part and/or the transport part comprises at least one composite material with at least one matrix material and with at least one functional or property component, wherein
a) the at least one matrix component comprises one or more of the materials aluminum, magnesium, ceramic, carbon, duromers, elastomers and/or thermoplastics, in particular thermosets, polymers, resins, polyester resins, polyurethane resins, polyurethane, epoxy resins, silicone resins, vinyl ester resins, phenol resins, acrylic resins, and
b) the property or functional component comprises or is composed of one or more of the materials glass fibers, carbon fibers, ceramic fibers, aramid fibers, boron fibers, steel fibers and/or nylon fibers, in particular in long fiber form.

4. The clip transport unit as claimed in claim 1, wherein the clip transport unit is part of a simultaneous pantograph stretching installation in which at least one component of the clip unit, of the control unit and/or the scissor levers is composed of one or more composite materials, in particular composite materials in the form of fiber composite materials or carbon fiber or glass fiber composite materials, in a volumetric or weight fraction of more than 25%, in particular more than 30%, 40%, 50%, 60%, 70%, 80% or more than 90%.

5. The clip transport unit as claimed in claim 1, wherein tension straps and/or reinforcement parts are inlaid and encapsulated in and/or pressed into the material of the clip transport units.

6. The clip transport unit as claimed in claim 1, wherein the transport parts are composed of chain parts which are parts of a transport chain, wherein tension straps and/or reinforcement parts are inlaid and encapsulated in and/or pressed into the material of the transport chain.

7. The clip transport unit as claimed in claim 1, wherein the composite material of the clip transport unit can be produced by means of at least one of the following methods: by means of the vacuum pressing method, by means of the prepreg method, by means of the vacuum infusion method, by means of the fiber winding method, by means of the injection molding method, by means of the transfer molding method, by means of the pultrusion method or by means of a sheet molding compound method.

8. The clip transport unit as claimed in claim 1, wherein the clip transport unit is divided along one or more virtual parting planes.

9. The clip transport unit as claimed in claim 1, wherein a plane of weight symmetry running through the center of gravity of the clip transport unit, and thus the weight vector of the clip transport unit, runs through the guide rail, which is if appropriate in the form of a support rail, and/or through a possibly additionally provided running surface of a support rail which supports the clip transport unit.

10. The clip transport unit as claimed in claim 1, furthermore wherein the following features:
the clip chain unit is also acted on, in a manner dependent on the track section of the guide path, by centrifugal forces and lateral guidance forces and transverse forces,
the centrifugal forces act in a centrifugal force plane which is parallel to the stretching plane and which runs through the center of gravity of the clip transport units,
the transverse force plane or the lateral guidance forces act in a plane which is parallel to the stretching force plane,
the centrifugal force plane and the lateral guidance or transverse force plane and the stretching force plane lie above the lower edge of the guide rail or within the remote delimiting edges of the slide or roller bearings which are supported on the guide rail, and
a support rail is also provided for accommodating and supporting the weight force of the clip chain unit.

11. The clip transport unit as claimed in claim 1, wherein the following features:
the clip chain unit is also acted on, in a manner dependent on the track section of the guide path, by centrifugal forces, lateral guidance forces and transverse forces,
the centrifugal forces act in a centrifugal force plane which is parallel to the stretching plane,
the transverse force plane or the lateral guidance forces act in a plane which is parallel to the stretching force plane,
the centrifugal force plane and the lateral guidance or transverse force plane and the stretching force plane lie within the slide or roller bearing arrangements, in particular within the lower edges of the slide or roller bearing arrangements, which are guided by one or more guide rails, and
at least one surface of the guide rail is provided for accommodating and supporting the weight force of the clip chain unit.

12. The clip transport unit as claimed in claim 11, wherein two or more of the planes, specifically the stretching force plane, the centrifugal force plane and the transverse force or lateral guidance force plane, coincide.

13. The clip transport unit as claimed in claim 1, wherein
the clip transport unit is also acted on, in a manner dependent on the track section of the guide path, by centrifugal forces,
the centrifugal force plane and the stretching force plane lie above the lower edge of the guide rail or within the remote delimiting edges of the slide or roller bearings, which are supported on the guide rail, and
the centrifugal force plane lies parallel to and spaced apart from, or coincides with, the stretching force plane.
